(19) United States
(12) Patent Application Publication
(10) Pub. No.: US 2026/0285301 A1
(43) Pub. Date: Sep. 24, 2026

(54) DRIVING ASSISTANCE APPARATUS

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Akitaka YAGUCHI, Tokyo (JP); Koichi TSUCHIYA, Ebina-shi, Kanagawa-ken (JP)

(21) Appl. No.: 19/568,363

(22) Filed: Mar. 16, 2026

(30) Foreign Application Priority Data
Mar. 18, 2025 (JP) 2025-042993

(51) Int. Cl. B60W 30/09; B60W 10/18; B60W 30/095; B60W 30/18

(52) U.S. Cl. CPC B60W 30/09; B60W 10/18; B60W 30/0956; B60W 30/18159; B60W 2420/403; B60W 2420/408; B60W 2520/10; B60W 2552/30; B60W 2554/4041; B60W 2554/801; B60W 2554/802

(57) ABSTRACT

A driving assistance apparatus mounted on a vehicle includes an object information obtainer, a determiner, and a braking controller. The object information obtainer derives object information about a target object. The determiner works to analyze a speed and a turning radius of the vehicle and the object information to determine whether the vehicle is intended to merge into a curved road, and whether the target object on the curved road is attempting to avoid the vehicle. The braking controller works to suppress braking of the vehicle, the braking being performed to avoid a collision between the vehicle and the target object, when it is determined that the vehicle is about to merge into the curved road and that the target object on the curved road is attempting to avoid the vehicle. This minimizes unnecessary braking of the vehicle when being about to merge into the curved road.

### CROSS REFERENCE TO RELATED DOCUMENT

The present application claims the benefit of priority of Japanese Patent Application No. 2025-42993 filed on Mar. 18, 2025, the disclosure of which is incorporated in its entirety herein by reference.

### TECHNICAL FIELD

This disclosure relates generally to a driving assistance apparatus.

### BACKGROUND ART

A technique is known in which an obstacle which has a risk of collision with a vehicle is detected, and the collision of the vehicle with the obstacle is avoided by executing various types of control, such as automatic braking and collision avoidance steering. For example, Japanese patent first publication No. 2010-30513 discloses a driving assistance apparatus that avoids a collision with an obstacle by taking into account both an object that is visually recognizable by a driver of the vehicle and an object that is difficult for the driver to visually recognize.

In a situation in which a vehicle is about to merge into a curved road, when an object traveling on the road is approaching toward the vehicle, braking of the vehicle may be required to avoid a collision with the object. However, thereafter, in a situation in which the object travels along the curve and moves away from the vehicle, braking may become unnecessary. Accordingly, in a situation in which the vehicle is intended to merge into the curved road, a technology for suppressing unnecessary braking of the vehicle is sought.

### SUMMARY

This disclosure has been made in order to solve the above problem. Such problem solving is achieved by the following aspect.

A driving assistance apparatus (100) mounted on a vehicle (VC), comprises: a vehicle information obtainer (11), an object information obtainer (12), a determiner (14), and a braking controller (15). The vehicle information obtainer works to obtain vehicle information including a speed of the vehicle and a turning radius of the vehicle using a first sensor (40) mounted on the vehicle. The object information obtainer works to obtain object information about a target object (TG) using a second sensor (30) mounted on the vehicle. The determiner (14) analyzes the speed, the turning radius, and the object information to determine whether the vehicle is in a situation in which the vehicle is intended to merge into a curved road (RB), and whether the target object traveling on the curved road is attempting to avoid the vehicle. The braking controller works to suppress braking of the vehicle, the braking being performed to avoid a collision between the vehicle and the target object, when the determination unit determines that the vehicle is in a situation in which the vehicle is intended to merge into the curved road and that the target object on the curved road is attempting to avoid the vehicle.

According to the above aspect, when the determiner determines that the vehicle is in a situation in which the vehicle is about to merge into a curved road and that the target object on the curved road is trying or attempting to avoid the vehicle, the braking controller works to suppress the braking of the vehicle, the braking being performed to avoid a collision between the vehicle and the target object, thereby making it possible to suppress unnecessary braking of the vehicle when merging into the curved road.

### BRIEF DESCRIPTION OF THE DRAWINGS

The present disclosure will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram illustrating a schematic configuration of a driving assistance apparatus according to an embodiment;

FIG. 2 is a diagram which demonstrates an example in which braking of a vehicle is suppressed;

FIG. 3 is a flowchart which illustrates a sequence of braking suppression steps according to an embodiment;

FIG. 4 is a flowchart which illustrates a sequence of curved road merging determination steps according to an embodiment; and

FIG. 5 is a flowchart which illustrates a sequence of collision avoidance traveling determination steps according to an embodiment.

### DESCRIPTION OF THE PREFERRED EMBODIMENTS

### Overall Configuration of Driving Assistance Apparatus 100

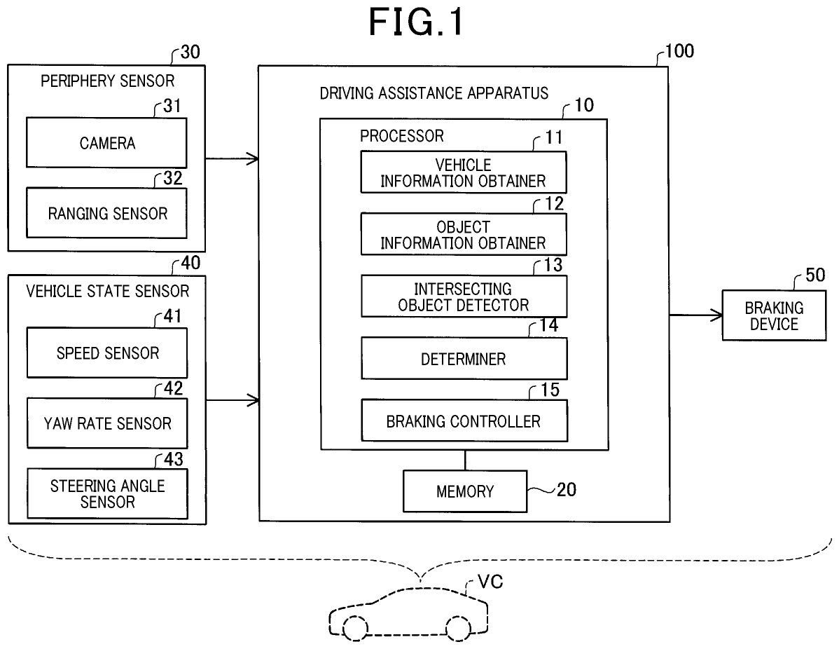

The driving assistance apparatus 100 shown in FIG. 1 is mounted on the vehicle VC in use and works to assist driving of the vehicle VC. In the following discussion, the vehicle VC will also be referred to as the system-equipped vehicle VC or ego vehicle VC. The vehicle VC may be any vehicle, such as an engine vehicle, a hybrid vehicle (HEV), a plug-in hybrid vehicle (PHEV), an electric vehicle (EV), or a fuel cell vehicle (FCV or FCHV). The vehicle VC is configured such that automatic driving and manual driving are switchable. The term “automatic driving” means driving in which drive control, brake control, and steering control are automatically executed in place of a vehicle driver. The term “manual driving” means driving in which an operation for drive control, an operation for brake control, and an operation for steering control are executed by the driver.

The vehicle VC is, as illustrated in FIG. 1, equipped with the driving assistance apparatus 100, the periphery sensors 30, the vehicle state sensors 40, and the braking device 50. The driving assistance apparatus 100 is communicably connected to the periphery sensors 30, the vehicle state sensors 40, and the braking device 50 via an in-vehicle network. The driving assistance apparatus 100 works to assist driving by controlling the braking device 50 using information obtained from the periphery sensors 30 and the vehicle state sensors 40.

The periphery sensors 30 work to detect an object located around the vehicle VC. Specifically, the periphery sensors 30 include the camera 31 and the ranging sensor 32. The camera 31 captures images of surroundings of the vehicle VC to acquire image data. The ranging sensor 32 measures a distance to an object around the vehicle VC. In the present embodiment, a millimeter-wave radar is used as the ranging sensor 32; however, LiDAR (Light Detection and Ranging), sonar, or the like may be used instead.

The vehicle state sensors 40 work to detect or measure traveling states of the vehicle VC. Specifically, the vehicle state sensors 40 include the vehicle speed sensor 41, the yaw rate sensor 42, and the steering angle sensor 43. The vehicle speed sensor 41 measures a speed of the vehicle VC. The yaw rate sensor 42 detects a yaw rate (an angular velocity of rotation) around a vertical axis passing through the center of gravity of the vehicle VC. The steering angle sensor 43 detects a steering angle of the vehicle VC.

The braking device 50 works to apply a braking force to the vehicle VC to decelerate the vehicle VC. In a case of manual driving, the braking device 50 applies the braking force in response to depression of a brake pedal by a driver. In a case of automatic driving, the braking device 50 applies the braking force in response to an instruction from the driving assistance apparatus 100 via the in-vehicle network.

The driving assistance apparatus 100 is implemented by a computer including the processor 10 and the memory 20. The computer may be, for example, an ECU (Electronic Control Unit). The processor 10 executes a program stored in advance in the memory 20, thereby functioning as the vehicle information obtainer 11, the object information obtainer 12, the intersecting object detector 13, the determiner 14, and the braking controller 15.

The vehicle information obtainer 11 acquires vehicle information using the vehicle state sensors 40 mounted on the ego vehicle VC. The vehicle information includes various types of information related to the ego vehicle VC, such as a speed, a yaw rate, a steering angle, and a turning radius of the ego vehicle VC. In the present embodiment, the vehicle state sensors 40 will also be referred to below as a first sensor.

The object information obtainer 12 acquires object information about an object located around the ego vehicle VC using the periphery sensors 30 mounted on the ego vehicle VC. Hereinafter, the object detected by the periphery sensors 30 will also be referred to as the target object TG. The object information includes various types of information related to the target object TG, such as a shape of the target object TG, information about the position of the target object TG relative to the ego vehicle VC, a speed of the target object TG, and a yaw rate of the target object TG. In the present embodiment, the periphery sensors 30 will also be referred to below as a second sensor.

The intersecting object detector 13 works to determine whether the target object TG intersects with the ego vehicle VC based on a traveling trajectory of the ego vehicle VC and a traveling trajectory of the target object TG. The traveling trajectory of the ego vehicle VC is predicted using the vehicle information. The traveling trajectory of the target object TG is predicted using the object information.

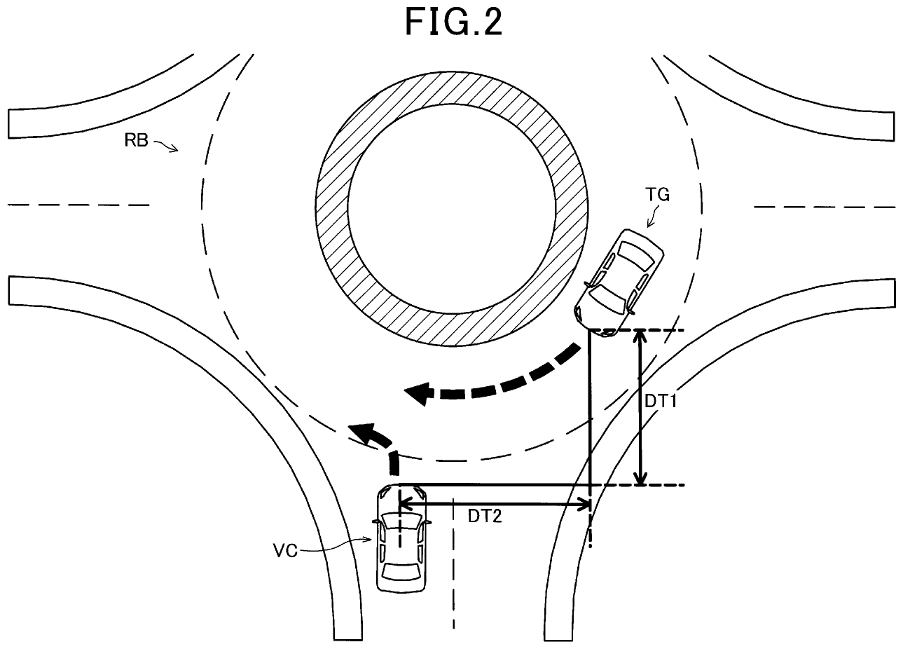

The determiner 14 determines whether the ego vehicle VC is in a situation of merging into the curved road RB, by using the speed and the turning radius of the ego vehicle VC derived from the vehicle information acquired by the vehicle information obtainer 11. In the present embodiment, the curved road RB is a roundabout. The roundabout refers to an intersection, as demonstrated in FIG. 2, in which a portion of the road on which the ego vehicle VC travels is annular and the ego vehicle VC is designated to travel in a clockwise direction. In the example illustrated in FIG. 2, the ego vehicle VC is attempting to merge into the curved road RB after temporarily stopping in front of the curved road RB.

Further, the determiner 14 determines whether the target object TG on the curved road RB is traveling so as to avoid the ego vehicle VC, by using the information about the position of the target object TG relative to the ego vehicle VC derived from the object information acquired by the object information obtainer 12. In the example illustrated in FIG. 2, the target object TG is traveling from a diagonally right-front side of the ego vehicle VC toward the front side of the ego vehicle VC. However, since the target object TG is traveling along the curved road RB, it can be said that the target object TG is traveling so as to avoid the ego vehicle VC. Specific procedures for determining whether the ego vehicle VC is in a situation of merging into the curved road RB and whether the target object TG on the curved road RB is traveling so as to avoid the ego vehicle VC will be described later.

The braking controller 15 works to suppress braking of the ego vehicle VC which is being made to avoid a collision between the ego vehicle VC and the target object TG. Here, the term “braking” refers to braking that is executed by the braking device 50 in the automated driving mode. The term “suppressing braking” means suppressing application of a braking force to the ego vehicle VC by the braking device 50. Suppression of braking is executed in response to an instruction from the driving assistance apparatus 100 to the braking device 50 via the in-vehicle network. The braking controller 15 also determines whether braking of the ego vehicle VC is being executed.

### Braking Suppression Task

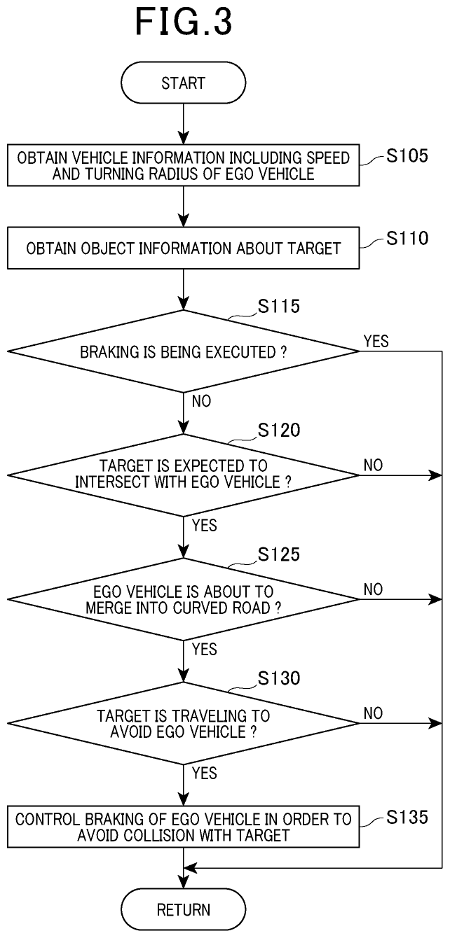

The braking suppression task, as can be seen in illustrated in FIG. 3, refers to a task in which the braking controller 15 suppresses braking of the ego vehicle VC. The braking suppression task is started upon activation of the driving assistance apparatus 100 and is thereafter repeatedly executed.

FIG. 3 is a flowchart of a sequence of logical steps or braking suppression program executed by the driving assistance apparatus 100. After entering the program, the routine proceeds to step S105 wherein the vehicle information obtainer 11 acquires the vehicle information including a speed and a turning radius of the ego vehicle VC by using the vehicle state sensors 40 mounted on the ego vehicle VC.

The routine proceeds to step S110 wherein the object information obtainer 12 acquires the object information about the target object TG located around the ego vehicle VC by using the periphery sensors 30 mounted on the ego vehicle VC. In the example illustrated in FIG. 2, the periphery sensors 30 mounted on the ego vehicle VC detect the target object TG located on a diagonally right-front side of the ego vehicle VC. In the present embodiment, the target object TG is a vehicle traveling clockwise on the curved road RB. The object information includes various kinds of information relating to the target object TG, such as a shape of the target object TG, information about the position of the target object TG with respect to the ego vehicle VC, a speed of the target object TG, and a yaw rate of the target object TG.

The position information representing the position of the target object TG relative to the ego vehicle VC includes information relating to a distance from the ego vehicle VC to the target object TG along a longitudinal direction, also referred to as a front-rear direction, of the ego vehicle VC (hereinafter also referred to as a first distance DT1), and information relating to a distance from the ego vehicle VC to the target object TG along a width direction of the ego vehicle VC (hereinafter also referred to as a second distance DT2). The first distance DT1 and the second distance DT2 are used in an avoidance traveling determination process to be described later to determine whether the target object TG on the curved road RB is traveling so as to avoid the ego vehicle VC.

The routine proceeds to step s115 wherein the braking controller 15 determines whether braking by the braking device 50 is being executed. If a YES answer is obtained, meaning that the braking by the braking device 50 is being executed, then the routine returns back to S105.

Alternatively, if a NO answer is obtained in step S115, meaning that the braking by the braking device 50 is not being executed, then the routine proceeds to step S120 wherein the intersecting object detector 13 detects whether the target object TG is expected to intersect with the ego vehicle VC based on the traveling trajectory of the ego vehicle VC and the traveling trajectory of the target object TG. The traveling trajectory of the ego vehicle VC is calculated or predicted using vehicle information. The traveling trajectory of the target object TG is calculated or predicted using object information. If a NO answer is obtained in step S210 meaning that the target object TG does not intersect with the ego vehicle VC, then the routine returns back to step S105.

If a YES answer is obtained in step S120, meaning that the intersecting object detector 13 determines that the target object TG is expected to intersect with the ego vehicle VC, then the routine proceeds to step S125 wherein the determiner 14 uses the speed and turning radius of the ego vehicle VC derived from the vehicle information acquired by the vehicle information obtainer 11 to determine whether the ego vehicle VC is about to or intended to merge into the curved road RB. How to determine whether the ego vehicle VC is about to merge into the curved road RB will be described in a curved-road merging determination process described later. If a NO answer is obtained in step S125, meaning that the determiner 14 determines that the ego vehicle VC is not about to merge into the curved road RB, then the routine returns back to step S105.

If a YES answer is obtained in step S130, meaning that the determiner 14 determines that the ego vehicle VC is about to merge into the curved road RB, then the routine proceeds to step S130 wherein the determiner 14 uses the position of the target object TG relative to the ego vehicle VC derived from the object information acquired by the object information obtainer 12 to determine whether the target object TG on the curved road RB is traveling so as to avoid the ego vehicle VC. How to determine whether the target object TG on the curved road RB is traveling so as to avoid the ego vehicle VC will be described in an avoidance traveling determination process described later. If a NO answer is obtained in step S130, meaning that the target object TG moving on the curved road RB is not traveling so as to avoid the ego vehicle VC, then the routine returns back to step S105.

If a YES answer is obtained in step S130, meaning that the determiner 14 determines that the target object TG on the curved road RB is traveling so as to avoid the ego vehicle VC, then the routine proceeds to step S135 wherein the braking controller 15 suppresses braking of the ego vehicle VC, the braking being performed to avoid an accidental collision between the ego vehicle VC and the target object TG. This minimizes braking of the ego vehicle VC in a situation in which the target object TG is attempting to avoid the collision with the ego vehicle VC.

### Curved-Road Merging Determination

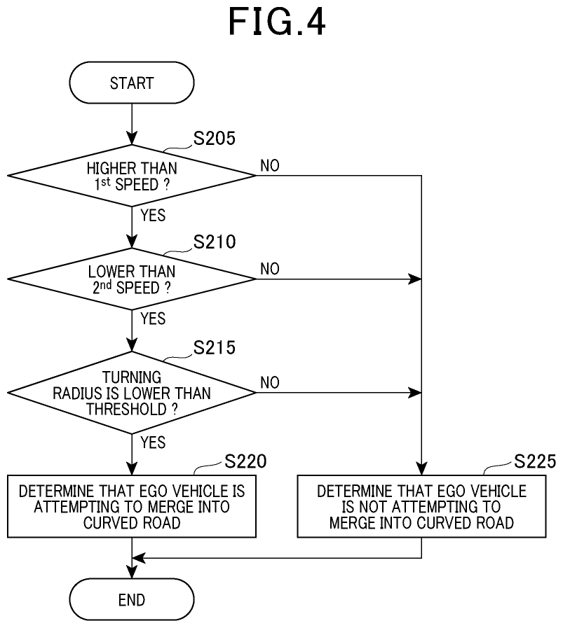

FIG. 4 illustrates a curved-road merging determination task that is a process in step S125 of FIG. 3 to determine whether the ego vehicle VC is in a situation where the ego vehicle VC is about to merge into the curved road RB. The curved-road merging determination task is started by the determiner 14 when the braking suppression task reaches S125.

In step S205, the determiner 14 determines whether the speed of the ego vehicle VC is equal to or higher than a first speed. The first speed is set to a small value as compared with a speed during normal traveling, such as, for example, 0.1 km/h (kilometers per hour). If a NO answer is obtained in step S205, meaning that the determiner 14 determines that the speed of the ego vehicle VC is lower than the first speed, then the routine proceeds to step S225 wherein the determiner 14 determines that the ego vehicle VC is not intended to merge into the curved road RB. That is, in this case, the determiner 14 determines that the ego vehicle VC is in a stopped state or a state close thereto.

If a YES answer is obtained in step S205, meaning that the determiner 14 determines that the speed of the ego vehicle VC is equal to or higher than the first speed, then the routine proceeds to step S210 wherein the determiner 14 determines whether the speed of the ego vehicle VC is lower than a second speed that is higher than the first speed. The second speed is set to, for example, a maximum speed that is usually assumed in a scene in which the ego vehicle VC transitions from a stopped state to a traveling state. If a NO answer is obtained in step S210, meaning that the determiner 14 determines that the speed of the ego vehicle VC is equal to or higher than the second speed, then the routine proceeds to step S225 to make the determination described above. Specifically, in this case, the determiner 14 determines that the ego vehicle VC is in a state of normally traveling on a road.

If a YES answer is obtained in step S210, meaning that the speed of the ego vehicle VC is lower than the second speed, that is, the determiner 14 determines that the ego vehicle VC is in a state transitioning from a stopped state to a traveling state, then the routine proceeds to step S215 wherein the determiner 14 determines whether the turning radius of the ego vehicle VC is smaller than a predetermined threshold. The predetermined threshold is set to, for example, a maximum turning radius that is usually assumed in a scene in which the ego vehicle VC merges into the curved road RB. If a NO answer is obtained in step S215, meaning that the determiner 14 determines that the turning radius of the ego vehicle VC is equal to or greater than the predetermined threshold, then the routine proceeds to step S225 to make the determination described above.

Alternatively, if a YES answer is obtained in step S215, meaning that the determiner 14 determines that the turning radius of the ego vehicle VC is smaller than the predetermined threshold, then the routine proceeds to step S220 wherein the determiner 14 determines that the ego vehicle VC is in a scene in which the ego vehicle VC is about to merge into the curved road RB.

### Avoidance Traveling Determination

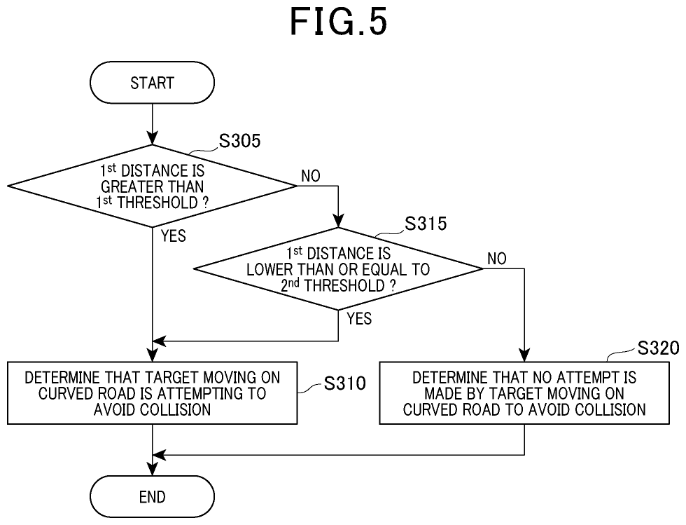

FIG. 5 illustrates an avoidance traveling determination task that is a process for determining whether the target object TG moving on the curved road RB is traveling so as to avoid the ego vehicle VC in S130 described above. The avoidance traveling determination task is started by the determiner 14 when the braking suppression task reaches S130.

Upon entering the program in FIG. 5, then routine proceeds to step S305 wherein the determiner 14 determines whether a first distance DT1 (see FIG. 2), which is a distance from the ego vehicle VC to the target object TG along the longitudinal direction of the ego vehicle VC, is equal to or greater than a first threshold. The first threshold, as referred to herein, is set to one of different values which is selected as a function of a second distance DT2 (see FIG. 2), which is a distance from the ego vehicle VC to the target object TG along the width direction of the ego vehicle VC. More specifically, the first threshold is set so as to have a larger value as the second distance DT2 becomes larger. This obtains an appropriate value of the first threshold depending on the position of the target object TG on the curved road RB. The first threshold is set based on, for example, data obtained by experimentally determining the first distance DT1 in a case where the target object TG on the curved road RB is traveling so as to avoid the ego vehicle VC. Note that the first threshold may be set to a value proportional to an absolute value of the second distance DT2, or may be set to a value that increases exponentially with respect to the absolute value of the second distance DT2.

If a YES answer is obtained in step S305, meaning that the determiner 14 determines that the first distance DT1 is equal to or greater than the first threshold, then the routine proceeds to step S310 wherein the determiner 14 determines that the target object TG moving on the curved road RB is attempting to avoid the ego vehicle VC.

Alternatively, if a NO answer is obtained in step S305, meaning that the determiner 14 determines that the first distance DT1 is lower than the first threshold, then the routine proceeds to step S315 wherein the determiner 14 determines whether the first distance DT1 is equal to or lower than the second threshold. The second threshold is set to an arbitrary value smaller than the first threshold.

By setting the second threshold, for example, execution of braking is suppressed in a situation in which a collision between the ego vehicle VC and the target object TG cannot be avoided regardless of whether the ego vehicle VC executes braking. The situation in which a collision between the ego vehicle VC and the target object TG cannot be avoided is, for example, a situation in which the target object TG approaches the ego vehicle VC from a lateral direction or from a rear direction. This, therefore, eliminates or minimizes a risk that the ego vehicle VC may collide with the target object TG when the target object TG approaches the ego vehicle VC from behind or mitigates an impact of a collision with the target object TG. The determiner 14 suppresses braking of the ego vehicle VC based on the determination that the target object TG moving on the curved road RB is attempting to avoid the ego vehicle VC. The second threshold is set based on, for example, data obtained by experimentally determining the first distance DT1 in a case corresponding to the above-described situation. Note that the second threshold may be set to a positive value smaller than the first threshold, or may be set to zero or a negative value.

If a YES answer is obtained in step S315, meaning that the determiner 14 determines that the first distance DT1 is equal to or lower than the second threshold, then the routine proceeds to step S310 to execute the termination described above.

Alternatively, if a NO answer is obtained in step S315, meaning that the determiner 14 determines that the first distance DT1 exceeds the second threshold, then the routine proceeds to step S320 that the determiner 14 determines that the target object TG moving on the curved road RB is not attempting to avoid the ego vehicle VC.

As apparent from the above discussion, when the determiner 14 determines that the ego vehicle VC is likely to merge into the curved road RB and that the target object TG moving on the curved road RB is attempting to avoid the ego vehicle VC, the driving assistance apparatus 100 works to suppress, by the braking controller 15, braking of the ego vehicle VC, the braking being performed to eliminate a risk of collision between the ego vehicle VC and the target object TG. This minimizes unnecessary braking of the ego vehicle VC when the ego vehicle VC is in a situation where it is intended to merge into the curved road RB.

The determiner 14 is designed to determine whether the ego vehicle VC is about to merge into the curved road RB by using the speed and the turning radius of the ego vehicle VC, and determines whether the target object TG traveling on the curved road RB is attempting to avoid the ego vehicle VC by using the object information. This enables the determiner 14 to determine, by separate flows of logical steps, whether the ego vehicle VC is in a situation where it is intended to merge into the curved road RB and whether the target object TG traveling on the curved road RB is attempting to avoid the ego vehicle VC.

The determiner 14 is also designed to determine whether the target object TG traveling on the curved road RB is attempting to avoid the ego vehicle VC using the information about the position of the target object TG. In a situation in which the target object TG approaches the ego vehicle VC from a front side of the ego vehicle VC, it is known that the speed and the yaw rate of the target object TG are likely to be erroneously detected. The determiner 14 is therefore designed to use the information about the position of the target object TG, which has higher reliability as compared with the speed and the yaw rate of the target object TG, to determine whether the target object TG traveling on the curved road RB is attempting to avoid the ego vehicle VC.

The determiner 14 is designed to determine that the target object TG traveling on the curved road RB is attempting to avoid the ego vehicle VC when the first distance DT1 is determined to be equal to or greater than the first threshold. In other words, the determiner 14 uses the first threshold to determine whether the target object TG traveling on the curved road RB is attempting to avoid the ego vehicle VC.

Further, the first threshold is set so as to have a larger value as the second distance DT2 becomes larger, thereby enabling the determiner 14 to use the first threshold to determine whether the target object TG traveling on the curved road RB is attempting to avoid the ego vehicle VC. It is, therefore, possible to select an appropriate value of the first threshold as a function of the position of the target object TG on the curved road RB.

The determiner 14 is also designed to determine that the target object TG traveling on the curved road RB is attempting to avoid the ego vehicle VC when the first distance DT1 is determined to be equal to or lower than the second threshold that is smaller than the first threshold. In other words, the determiner 14 is designed to use the second threshold that is smaller than the first threshold to determine that the target object TG traveling on the curved road RB is attempting to avoid the ego vehicle VC. Further, the braking controller 15 is designed to suppress braking of the ego vehicle VC in a situation in which the target object TG is approaching the ego vehicle VC from a lateral direction or from a rear direction, that is, a situation in which it is difficult to avoid a collision between the ego vehicle VC and the target object TG. Accordingly, for example, in a situation in which the target object TG is approaching the ego vehicle VC from behind, there is a possibility that a collision with the target object TG can be avoided or an impact of a collision with the target object TG can be mitigated.

### OTHER EMBODIMENTS

In the present embodiment, the target object TG is a vehicle; however, the present disclosure is not limited thereto. The target object TG may be, for example, a bicycle, a pedestrian, an animal, or the like.

The driving assistance apparatus 100 in the present embodiment includes the intersecting object detector 13; however, the present disclosure may omit the intersecting object detector 13. In association therewith, the operation in step S120 in the braking suppression task may be skipped.

In the present embodiment, the curved road RB is a roundabout; however, the present disclosure is not limited thereto. The curved road RB may be the curved road RB other than a roundabout.

In the present embodiment, the determiner 14 is configured to analyze the speed and the turning radius of the ego vehicle VC to determine whether the ego vehicle VC is in a situation of merging into the curved road RB, and also use the information about the position of the target object TG relative to the ego vehicle VC to determine whether the target object TG traveling on the curved road RB is attempting to avoid the ego vehicle VC; however, the present disclosure is not limited thereto. The determiner 14 may determine, based on three types of information including speed, turning radius, and object information, both whether the ego vehicle VC is in a situation of merging into the curved road RB and whether the target object TG traveling on the curved road RB is attempting to avoid the ego vehicle VC.

In the present embodiment, the determiner 14 is configured to the information about the position of the target object TG to determine whether the target object TG traveling on the curved road RB is attempting to avoid the ego vehicle VC; however, the present disclosure is not limited thereto. The determiner 14 may determine, instead of the position information, whether the target object TG traveling on the curved road RB is attempting to avoid the ego vehicle VC by using, for example, the speed or the yaw rate of the target object TG.

In the present embodiment, the information about the position of the target object TG includes information on a distance from the ego vehicle VC to the target object TG in the longitudinal direction of the ego vehicle VC (i.e., the first distance DT1) and information on a distance from the ego vehicle VC to the target object TG in the width-direction of the ego vehicle VC (i.e., the second distance DT2); however, the present disclosure is not limited thereto. The position information of the target object TG may include only the information on the first distance DT1, or may include only the information on the second distance DT2. Alternatively, the position information of the target object TG may include, instead of the first distance DT1 or the second distance DT2, for example, information on a linear distance between the ego vehicle VC and the target object TG.

In the present embodiment, the first threshold is set to have a larger value as the second distance DT2 increases; however, the present disclosure is not limited thereto. The first threshold may be set to, for example, a constant value regardless of the magnitude of the second distance DT2.

In the present embodiment, the determiner 14 is configured to use the first threshold and the second threshold to determine that the target object TG traveling on the curved road RB is attempting to avoid the ego vehicle VC; however, the present disclosure is not limited thereto. The determiner 14 may determine, based only on the first threshold or based only on the second threshold, that the target object TG traveling on the curved road RB is attempting to avoid the ego vehicle VC.

The present disclosure may be implemented in various forms other than the form of the driving assistance apparatus 100. For example, the present disclosure may alternatively be implemented in the form of a driving assistance method, a curved road merging determination method, an avoidance traveling determination method, or a computer program for realizing the driving assistance apparatus 100.

The present disclosure is not limited to the above-described embodiments, and may be implemented with various configurations without departing from the spirit thereof. For example, technical features in the embodiments corresponding to the technical features described in the section of Summary of the Invention may be appropriately replaced or combined in order to solve part or all of the above-described problems or to achieve part or all of the above-described effects. In addition, if such a technical feature is not described as essential in the present specification, the technical feature may be appropriately omitted.

This disclosure is realized by the following aspects.

### FIRST ASPECT

A driving assistance apparatus (100) mountable on a vehicle (VC), comprises: a vehicle information obtainer (11), an object information obtainer (12), a determiner (14), and a braking controller (15). The vehicle information obtainer works to obtain vehicle information including a speed of the vehicle and a turning radius of the vehicle using a first sensor (40) mounted on the vehicle. The object information obtainer works to obtain object information about a target object (TG) using a second sensor (30) mounted on the vehicle. The determiner (14) analyzes the speed, the turning radius, and the object information to determine whether the vehicle is in a situation in which the vehicle is intended to merge into a curved road (RB), and whether the target object traveling on the curved road is attempting to avoid the vehicle. The braking controller works to suppress braking of the vehicle, the braking being performed to avoid a collision between the vehicle and the target object, when the determination unit determines that the vehicle is in the situation in which the vehicle is intended to merge into the curved road and that the target object on the curved road is attempting to avoid the vehicle.

### SECOND ASPECT

The driving assistance apparatus as set forth in the above-described first aspect, wherein the determiner uses the speed and the turning radius of the vehicle to determine whether the vehicle is in the situation in which the vehicle is about to merge into the curved road. The determiner uses the object information to determine whether the target object traveling on the curved road is attempting to avoid the vehicle.

### THIRD ASPECT

The driving assistance apparatus as set forth in the above-described first or second aspect, wherein the object information includes position information about a position of the target object relative to the vehicle. The determiner determines, using the position information, whether the target object traveling on the curved road is attempting to avoid the vehicle.

### FOURTH ASPECT

The driving assistance apparatus as set forth in the above-described third aspect, wherein the position information includes information on a first distance (DT1), which is a distance from the vehicle to the target object along a longitudinal direction of the vehicle. The determiner determines that the target object traveling on the curved road is attempting to avoid the vehicle when the first distance is greater than or equal to a first threshold or when the first distance is less than or equal to a second threshold that is smaller than the first threshold.

### FIFTH ASPECT

The driving assistance apparatus as set forth in the above-described fourth aspect, wherein the position information includes information on a second distance (DT2), which is a distance from the vehicle to the target object along a width direction of the vehicle. The first threshold is set to have a value increasing with an increase in the second distance.

What is claimed is:

1. A driving assistance apparatus (100) mountable on a vehicle (VC), comprising:
a vehicle information obtainer (11) configured to obtain vehicle information including a speed of the vehicle and a turning radius of the vehicle using a first sensor (40) mounted on the vehicle;
an object information obtainer (12) configured to obtain object information about a target object (TG) using a second sensor (30) mounted on the vehicle;
a determiner (14) configured to analyze the speed, the turning radius, and the object information to determine whether the vehicle is in a situation in which the vehicle is intended to merge into a curved road (RB), and whether the target object traveling on the curved road is attempting to avoid the vehicle; and
a braking controller (15) configured to suppress braking of the vehicle, the braking being performed to avoid a collision between the vehicle and the target object, when the determination unit determines that the vehicle is in the situation in which the vehicle is intended to merge into the curved road and that the target object on the curved road is attempting to avoid the vehicle.

2. The driving assistance apparatus as set forth in claim 1, wherein the determiner uses the speed and the turning radius of the vehicle to determine whether the vehicle is in the situation in which the vehicle is about to merge into the curved road, and
the determiner uses the object information to determine whether the target object traveling on the curved road is attempting to avoid the vehicle.

3. The driving assistance apparatus as set forth in claim 1, wherein the object information includes position information about a position of the target object relative to the vehicle, and
the determiner determines, using the position information, whether the target object traveling on the curved road is attempting to avoid the vehicle.

4. The driving assistance apparatus as set forth in claim 3, wherein the position information includes information on a first distance (DT1), which is a distance from the vehicle to the target object along a longitudinal direction of the vehicle, and
the determiner determines that the target object traveling on the curved road is attempting to avoid the vehicle in response to the first distance being greater than or equal to a first threshold or in response to the first distance being less than or equal to a second threshold that is smaller than the first threshold.

5. The driving assistance apparatus as set forth in claim 4, wherein the position information includes information on a second distance (DT2), which is a distance from the vehicle to the target object along a width direction of the vehicle, and
the first threshold is set to have a larger value as the second distance increases.
